(19) United States
(12) Patent Application Publication
(10) Pub. No.: US 2026/0277696 A1
(43) Pub. Date: Sep. 17, 2026

(54) DISTRIBUTION OF QUERY-BASED TASKS TO ON-NETWORK AI MODELS

(71) Applicant: Lenovo (United States) Inc., Morrisville, NC (US)

(72) Inventors: Scott Li, Morrisville, NC (US); Igor Stolbikov, Morrisville, NC (US); John W Nicholson, Morrisville, NC (US); Daryl C Cromer, Morrisville, NC (US)

(21) Appl. No.: 19/079,715

(22) Filed: Mar. 14, 2025

(51) Int. Cl. G06F 9/50; H04L 67/104

(52) U.S. Cl. CPC G06F 9/5055; G06F 9/5066; H04L 67/1051

(57) ABSTRACT

In one aspect, an apparatus includes a processor system and storage accessible to the processor system. The storage includes instructions executable by the processor system to determine one or more first capabilities of a first model executable on a first device connected to a network, and to determine one or more second capabilities of a second model executable on a second device connected to the network. The instructions are also executable to, based on the determinations, assign a first task to the first model to address a query and assign a second task to the second model to address the query. The instructions are then executable to coordinate the first and second tasks to respond to the query. In some examples, the instructions may also be executable to deconstruct the query into the first and second tasks to then assign the tasks based on both the determinations and the deconstruction.

### FIELD

The disclosure below relates to technically inventive, non-routine solutions that are necessarily rooted in computer technology and that produce concrete technical improvements. In particular, the disclosure below relates to techniques for distribution of query-based tasks to on-network artificial intelligence (AI) models.

### BACKGROUND

As recognized herein, smaller, specialized AI models may be installed on different devices on a home network. While this can be more secure and reduce latency compared to using larger AI models located on remote servers external to the home network, the disclosure below further recognizes that these home networks currently lack the technical capability to optimally use the individual AI models in concert with each other to perform complex tasks. This, in turn, results in non-responses and suboptimal responses to complex user queries, inefficiencies in task handling, and underutilization of the resources available on the home network. There are currently no adequate solutions to the foregoing computer-related, technological problems.

### SUMMARY

Accordingly, in one aspect a first device includes a processor system, a network system configured to connect to a local area network (LAN), and storage accessible to the processor system. The storage includes instructions executable by the processor system to identify user input indicating a query, determine one or more first capabilities of a first artificial intelligence (AI) model executable on a second device connected to the LAN, and determine one or more second capabilities of a second AI model executable on a third device connected to the LAN. The instructions are then executable to deconstruct the query into at least a first task and a second task, with the first task being different from the second task. The instructions are also executable to, based on the determinations, assign the first task to the first AI model and assign the second task to the second AI model.

In one example embodiment, one or both of the first and second AI models may include a large language model (LLM).

Also in one example embodiment, the instructions may be executable to receive, from the second device, first data indicating a first output from the first AI model as executed in conformance with the first task. Here the instructions may be further executable to receive, from the third device, second data indicating a second output from the second AI model as executed in conformance with the second task. The instructions may then be executable to output a response to the query based on the first and second data.

In addition, in some instances the instructions may be executable to deconstruct the query into the first and second tasks based on the identified one or more first capabilities of the first AI model and the one or more second capabilities of the second AI model.

Also in some instances, the instructions may be executable to elect the first device as an orchestrating device for coordinating the first and second tasks. If desired, the instructions may even be executable to identify one or more first real-time operational metrics for the first device, identify one or more second real-time operational metrics for a fourth device, and elect the first device based on analysis of the first and second real-time operational metrics. What's more, the first device and the fourth device may be selected as candidates for election based on the first device and fourth device each having a respective AI model capable of coordinating tasks with other devices. In addition, in some specific cases, the instructions may be executable to elect the first device over the fourth device based on the first real-time operational metrics indicating more resource availability than the second real-time operational metrics. Additionally, in some instances the instructions may be executable to elect the first device in consensus with one or more of the second device, the third device, and/or the fourth device. Still further, in some instances the fourth device may be one of the second device and the third device. Also in some instances, resource availability may pertain to one or more of processor utilization amount and/or memory utilization amount.

In addition to the foregoing, in some example embodiments the instructions may be executable to share one or more third capabilities of a third AI model responsive to detecting that the network system has connected to the LAN, where the third AI model may be executable on the first device. If desired, the one or more third capabilities may be shared using a multicast Domain Name System (mDNS) protocol.

In another aspect, a method includes identifying user input indicating a query, determining one or more first capabilities of a first artificial intelligence (AI) model executable on a first device connected to a local area network (LAN), and determining one or more second capabilities of a second AI model executable on a second device connected to the LAN. Based on the determinations, the method also includes assigning a first task to the first AI model to address the query, and assigning a second task to the second AI model to address the query. The method then includes coordinating the first and second tasks to address to the query.

If desired, the first AI model may be a large language model (LLM), while the second AI model may be a text-to-speech model. In addition, in some instances, coordinating the first and second tasks to address to the query may include prompting the first AI model to generate text, and then providing the generated text to the second AI model for the second AI model to then generate audio signals indicating words corresponding to the generated text.

In addition, in some cases the method may include deconstructing the query into the first task and the second task. Here the method may then include, based on the determinations and the deconstruction, assigning the first task to the first AI model to address the query and assigning the second task to the second AI model to address the query.

What's more, in some non-limiting instances the one or more first capabilities and the one or more second capabilities may be determined via a multicast Domain Name System (mDNS) protocol.

In still another aspect, an apparatus includes at least one computer readable storage medium (CRSM) that is not a transitory signal. The at least one CRSM includes instructions executable by a processor system to determine one or more first capabilities of a first model executable on a first device connected to a network. The instructions are also executable to determine one or more second capabilities of a second model executable on a second device connected to the network. Based on the determinations, the instructions are then executable to assign a first task to the first model to address a query and assign a second task to the second model to address the query. The instructions are further executable to coordinate the first and second tasks to respond to the query.

In one non-limiting example, coordinating the first task may include prompting the first model to execute the first task, and coordinating the second task may include prompting the second model to execute the second task.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example local area network (LAN) with multiple connected devices consistent with present principles;

FIG. 3 shows a schematic diagram of overall LLM device network interaction consistent with present principles;

FIGS. 4A and 4B shows a schematic diagram of an example orchestrator device election process consistent with present principles;

FIG. 5 shows a schematic diagram of an example use case where different LLMs in a user's personal residence are enlisted to address a user query consistent with present principles;

FIGS. 6 and 7 show example graphical user interfaces (GUIs) that may be presented on a display for a user to provide a query consistent with present principles; and

FIG. 8 illustrates example logic in example flow chart format that may be executed by an apparatus consistent with present principles.

### DETAILED DESCRIPTION

Among other things, the detailed description below provides systems and methods for employing small, specialized large language models (LLMs) and other types of AI models on different devices within a home environment in concert with each other. Other AI model types that may be used consistent with present principles include, but are not limited to, large multimodal models (LMMs) such as text-to-image and text-to-audio models, as well as other generative AI models and even discriminative AI models. In one particular example where LLMs are used, each LLM may be established by one or more generative pretrained transformers (GPTs).

The LLMs and/or other AI models themselves may be ones designed to run locally on client devices such as smartphones, personal computers like workstations and laptops, routers, and other devices with sufficient computational power. The LLMs may be relatively small in size and customized to specific domains if desired (e.g., possibly due to compute/memory constraint and personal assistance). Example domains include reasoning, coding, personal assistance, text summation, entertainment, and other specialized skills. Some of these LLMs may be personalized to individuals or groups, containing personal information and status updates.

The technical systems and methods discussed below provide an efficient method for these distributed, device-specific LLMs to discover each other and collaborate effectively within the home network, harnessing the collective computational power and specialized knowledge of the local device-based LLMs in task handling and response generation. This avoids each device-specific LLM operating in isolation, otherwise unable to leverage the specialized knowledge of other LLMs within the same home network and resulting in suboptimal responses to complex queries that may require multi-domain expertise. The mDNS discovery mechanism set forth herein may thus be used to efficiently route specific tasks or queries to the most appropriate device-specific LLM on the home network, further optimizing the available resources within the home network itself.

In one particular example, LLMs may be discovered and orchestrated within a local network environment by leveraging mDNS (Multicast DNS) for efficient peer LLMs discovery on the network (the network may additionally or alternatively be a server-side facilitation like Session Traversal Utilities for NAT (STUN), a cloud facilitator, etc.). Once discovered, the LLMs may engage in a dynamic election process to select an orchestrator based on real-time availability and capability metrics. This orchestrator may then manage task distribution and collaboration among the network's LLMs, maximizing the potential of the distributed, specialized LLMs within the local network. The task(s) might be a single task indicated in user input, which is then assigned to a single entity on the network. Additionally or alternatively, the task(s) may include plural tasks as decomposed or otherwise identified from the user input.

This advantageously leads to dynamic LLM discovery, with the system then using a dynamic discovery mechanism for continuous discovery and integration of AI models in local networks as time goes on. Also, an mDNS-based LLM announcement may provide for efficient peer LLM discovery on local networks, allowing each LLM to broadcast its capabilities and availability. What's more, in using a dynamic orchestrator election, devices may be dynamically elected as orchestrator LLM based on real-time availability and capability metrics within the local network. LLM meta descriptors may also be used, where detailed metadata for each LLM may be considered (including capabilities, specializations, and operational metrics) to enable intelligent task routing.

In terms of mDNS specifically, while other protocols may also be used consistent with present principles (e.g., MQTT and P2P), the mDNS protocol itself advantageously allows for “zero configuration” networking, making it a fitting if not optimal protocol for home and local network environments where emphasis is put on ease of use. mDNS may thus aids seamless LLM discovery and integration in ways that other protocols may not.

As also recognized herein, mDNS may provide local network efficiency in that mDNS may be optimized for efficient local network discovery, including home network discovery, providing advantages over using remotely-located cloud computing to do so. Still further, mDNS may also advantageously provide for real-time discovery of services (e.g., LLMs) as they join or leave the network, aiding the system's dynamic orchestration system.

As further recognized herein, other advantages of using mDNS include low overhead as, compared to some other protocols, mDNS may have relatively low overhead. This may make mDNS more suitable for resource-constrained devices that might be running LLMs in a home environment. Yet another advantage of mDNS that is recognized herein is its wide support amongst different devices and operating systems, facilitating seamless integration and implementation of different devices on the network. What's more, mDNS can operate in a decentralized manner, eliminating the need for a central server on the network while providing a resilient distributed system of LLMs. As another example, mDNS is also service-oriented in that it may be used for service discovery for discovering LLM services with specific capabilities.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single-or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

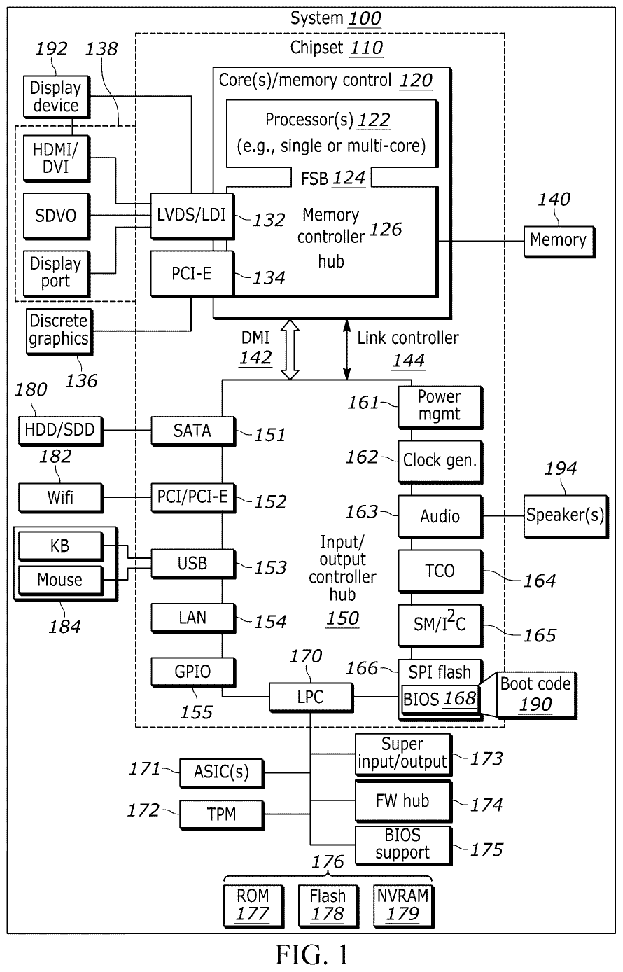

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

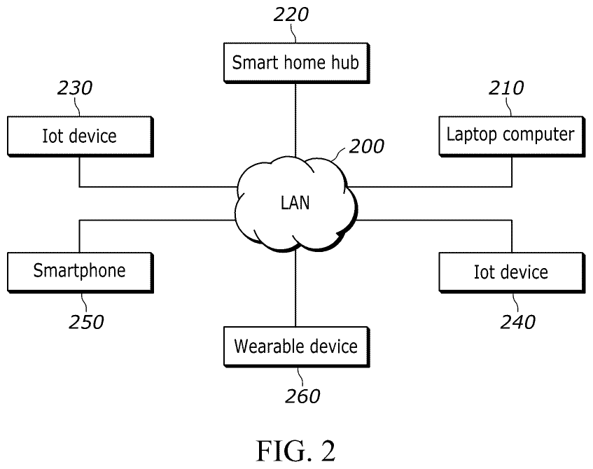

Turning now to FIG. 2, example devices are shown communicating over a local area network (LAN) 200, such as a Wi-Fi or Bluetooth network, consistent with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows that a laptop computer 210 and a smart home hub 220 may be connected to the LAN 200. The hub 220 may be embodied as a local server or client device. Also connected to the LAN 200 may be a first Internet of things (IoT) device 230, a second IoT device 240, a smartphone 250 or other mobile device, and a wearable device 260 such as a smartwatch or headset (e.g., smart glasses or augmented reality headset). Other types of client devices may also be connected to the LAN 200.

It is to be understood that the devices 210-260 may be configured to communicate with each other over the LAN 200 to undertake present principles, including sharing (e.g., broadcasting or multicasting) their respective AI model capabilities and other data to each other using a multicast Domain Name System (mDNS) protocol. However, other protocols may also be used, such as but not limited to message queuing telemetry transport (MQTT) or peer-to-peer (P2P) protocols. In some specific instances, each device may include a network system (e.g., transceiver) configured to connect to the LAN 200.

The LAN 200 and devices 210-260 may thus be used for discovering and orchestrating LLMs and other AI-based models within the LAN 200 environment. Multicast DNS may be leveraged for efficient peer large language model (LLM)/AI model discovery on the home network 200. Then once discovered, the LLMs may engage in a dynamic election process to select an orchestrator based on real-time availability and capability metrics. This orchestrator may then manage task distribution and collaboration among the network's LLMs and other AI models. This, in turn, may maximize the potential of the distributed, specialized LLMs and other AI models within the local network 200.

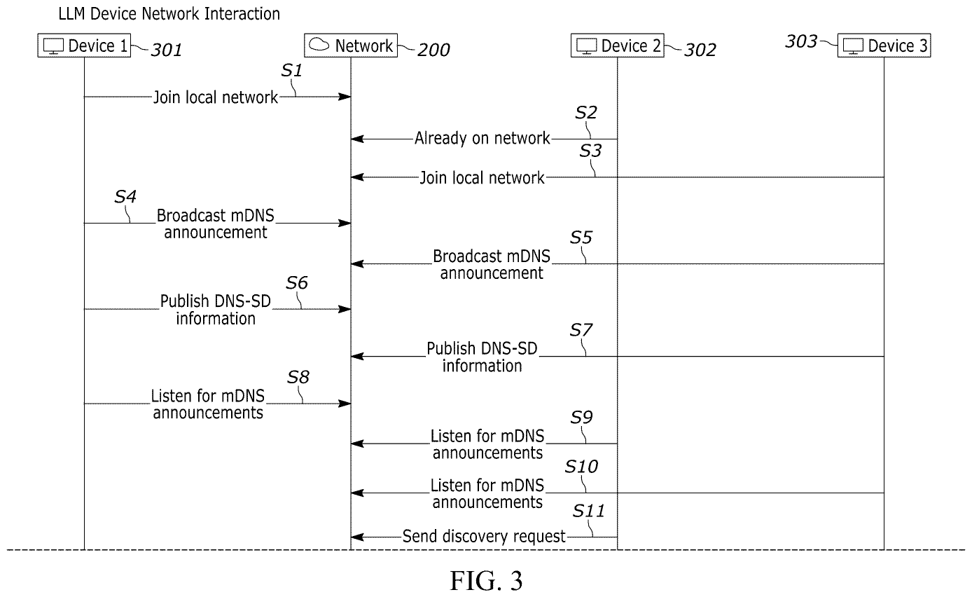

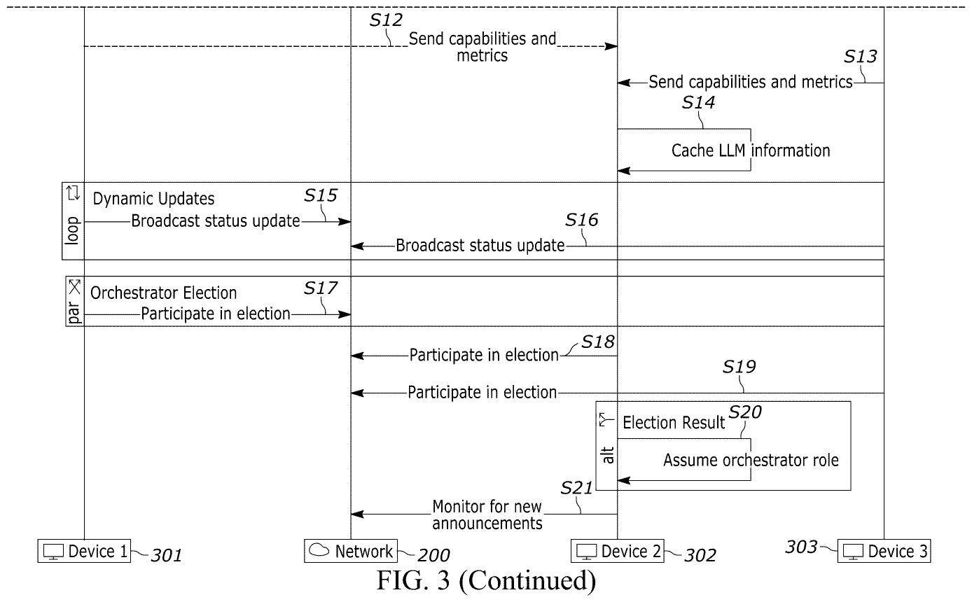

With the foregoing in mind, the schematic diagram of FIG. 3 further illustrates. Specifically, FIG. 3 shows example network interaction amongst local devices that each store and execute their own local AI model as installed on that respective device. Again note that example AI model types include, but are not limited to, LLMs, generative image models, generative audio models, text-to-speech models, and image-based object recognition models.

As shown in FIG. 3, respective devices 301-303 as actively connected to the LAN 200 may communicate with each other using the mDNS protocol. The devices 301-303 may be established by any of the devices 210-260 mentioned above, and/or by other local client devices connected to the LAN 200. Also note that more or less devices than those shown in FIG. 3 may be used in other examples.

The aforementioned network interaction may include a discovery sequence where the local client devices on the LAN 200 discover each other and exchange certain data, including data related to the capabilities of the respective AI models that are locally executable at the respective device itself. This sequence may therefore include the devices 301 and 303 joining the LAN 200 respectively at steps S1 and S3, with step S2 illustrating that the device 302 is already connected to the LAN 200.

For AI-enabled devices joining the LAN 200, initialization may be performed where the respective device initializes its discovery service. This may include the device 301 broadcasting or multicasting an mDNS announcement at step S4, and the device 303 broadcasting/multicasting its own mDNS announcement at step S5. The devices 301, 303 may also publish respective DNS service discovery (DNS-SD) information at steps S6 and S7.

Accordingly, the devices 301, 303 may use mDNS to broadcast respective announcements of their LLM or other AI model services on the local network 200. The announcements may include information like the respective device's Internet protocol (IP) address and a service identifier. In terms of the service information publication that occurs at steps S6 and S7, along with the mDNS announcements, each device 301, 303 may publish detailed service information using DNS-SD, including LLM/AI model capabilities (e.g., language proficiencies, domain expertise), hardware specifications (e.g., processing power, available memory), and current load and availability status.

Then at steps S8, S9, and S10, the respective devices 301-303 may listen for announcements from the other respective devices 301-303. Steps S8-S10 may occur concurrently (e.g., simultaneously) with steps S4-S7, with each device 301-303 listening for mDNS announcements from other LLM-enabled or AI-enabled devices on the network 200.

Then when a device 301-303 wishes to discover available LLMs and other AI-based models at a later time (e.g., when processing a query from a user), the respective device may send out a discovery request on the local network 200 at step S11. In some respects, the discovery request may be similar to an address resolution protocol (ARP) “who's there” message. Also note that in the present example, the device 302 is the one that sends out the discovery request at step S11.

Then in response to receiving the discovery request, at steps S12 and S13 the devices 301, 303 may respectively respond to the discovery request by sending data indicating the capabilities and metrics of the respective AI models stored at and executable on those devices. Thus, LLM-enabled devices and other AI-enabled devices that receive the discovery requests may each respond with their detailed capabilities, availability, and operational metrics.

Then at step S14, each device may engage in local information caching where the respective device 301-303 maintains a local cache in its local storage of discovered LLMs/AI models and their respective capabilities, updating this information in the local cache periodically or when changes are detected.

In terms of dynamic updates, it is to be further understood that AI and LLM-enabled devices may periodically broadcast updates about their status, load, and capabilities, allowing other devices on the network 200 to maintain an up-to-date view of the network's cumulative LLM resources. This is demonstrated at steps S15 and S16, where devices 301 and 303 broadcast or multicast status updates in a loop.

Then at some point, such as responsive to receiving user input of a query to the system, an orchestrator device election may be made. This is demonstrated at steps S17-S19, where the devices engage in a dynamic election process to select an orchestrator based on the discovered information from above. The election process may consider various factors like processing power, availability, and network position of each of the devices 301-303. Each device 301-303 may thus execute the same or a similar algorithm as part of its own independent orchestrator election, and then each device's election may be shared with the other devices 301-303. A consensus to elect a particular device as the orchestrator device may be used for the overall system to therefore elect that device as orchestrator. If no consensus (unanimity) is reached, the device receiving a plurality or majority of votes may be selected, or the process may alternatively repeat until consensus is reached.

Then at step S20, the elected orchestrator (and potentially other devices on the network 200) may continuously monitor the network 200 for new LLM/AI device announcements or changes in existing LLM devices'status. If another device is determined to have more resource availability than the currently-elected orchestrator device, orchestrator status may alternate to the other device to then assume the orchestrator role. Continuous monitoring for new announcements may then continue to occur at step S21 of FIG. 3.

As mentioned above, an mDNS protocol may be used consistent with present principles to exchange announcements and other information over a LAN. As such, a DNS naming convention may be used for local uniform resource locators (URLs). For example, the URLs might be:
imggen_expert.gemma.ai.local
text_analyst.llama.ai.local
code_generator.codex.ai.local

Additionally, example information extracted from LLM/AI model metadata as received over the network might include:
TXT records:
model=gemma
version=1.0
specialization=image generation
languages=en,fr
max_tokens=2048
cost_per_query=0.001

Providing a non-limiting example of an mDNS packet for an LLM/AI announcement, the packet might include the following:

### Ethernet Header

Destination: 01:00:5E:00:00:FB (IPv4 mDNS multicast address)
Source: 00:1A:2B:3C:4D:5E (Example MAC address of the LLM host)
Type: IPv4 (0x0800)

### IP Header

Version: 4
Header Length: 20 bytes
Type of Service: 0x00
Total Length: 362 bytes (example value)
Identification: 0x1234 (example value)
Flags: 0x00
Fragment Offset: 0
Time to Live: 255
Protocol: UDP (17)
Header Checksum: 0x5678 (example value)
Source IP: 192.168.1.100 (Example IP of the LLM host)
Destination IP: 224.0.0.251 (mDNS multicast address)

### UDP Header

Source Port: 5353 (mDNS port)
Destination Port: 5353 (mDNS port)
Length: 342 bytes (example value)
Checksum: 0xABCD (example value)
   mDNS Message

### Header:

Transaction ID: 0x0000 (typically zero for announcements)
Flags: 0x8400 (Standard query response, authoritative)
Questions: 0
Answer RRs: 1
Authority RRs: 0
Additional RRs: 1

### Answer Section:

Name: networking_expert.gemma._llm._tcp.local
Type: PTR (12)
Class: IN (1)
TTL: 120 seconds
Data Length: 37 bytes
Data: networking_expert.gemma._llm._tcp.local

### Additional Records Section

Name: networking_expert gemma._llm._tcp.local
Type: TXT (16)
Class: IN (1)
TTL: 120 seconds
Data Length: 180 bytes
TXT Record Data:
   model=gemma
   version=1.0
   specialization=networking
   languages=en,fr
   max_tokens=2048
   cost_per_query=0.001
   capabilities=network_analysis, troubleshooting
   deployment=local
   api_version=1.2
   last_updated=2024-08-30T12:00:00Z

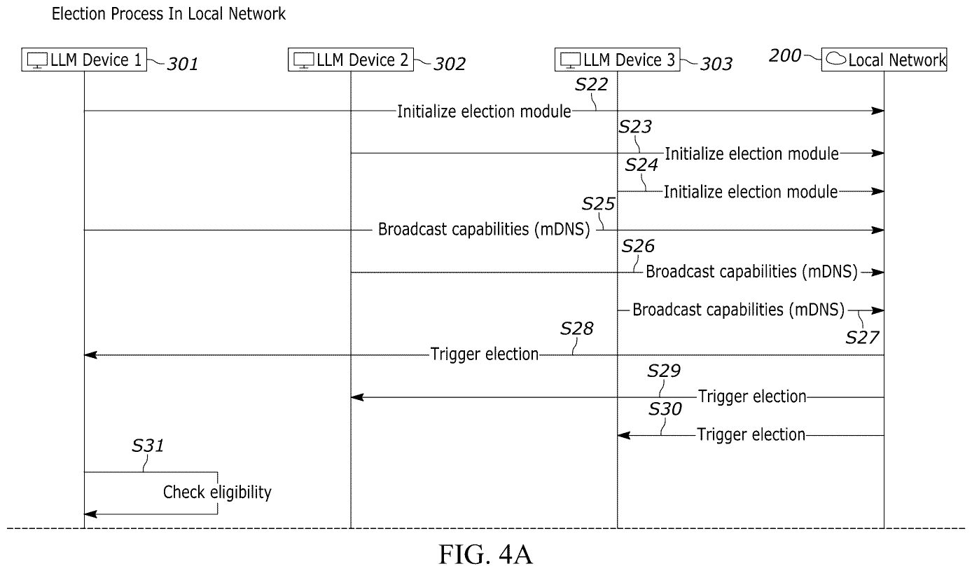

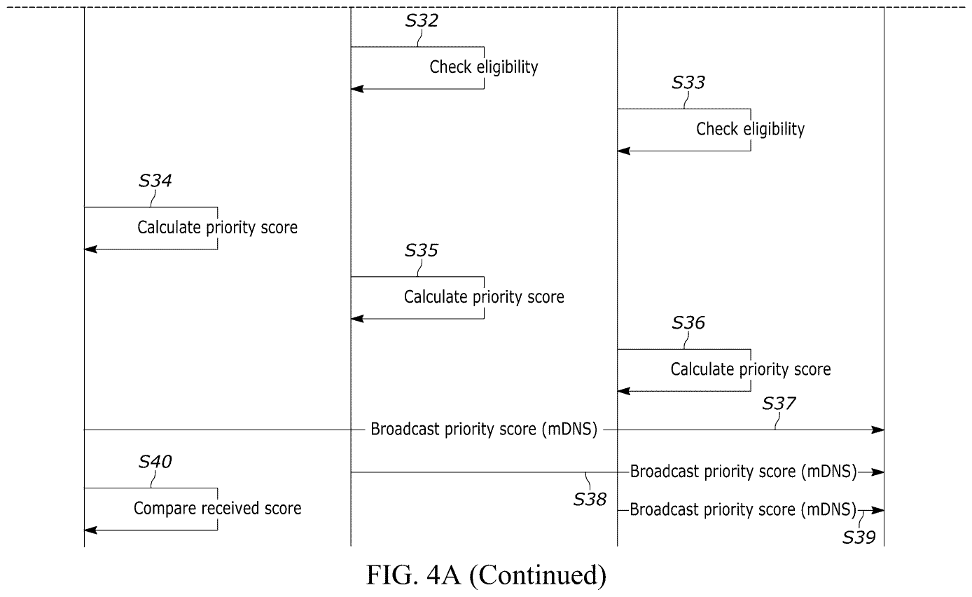

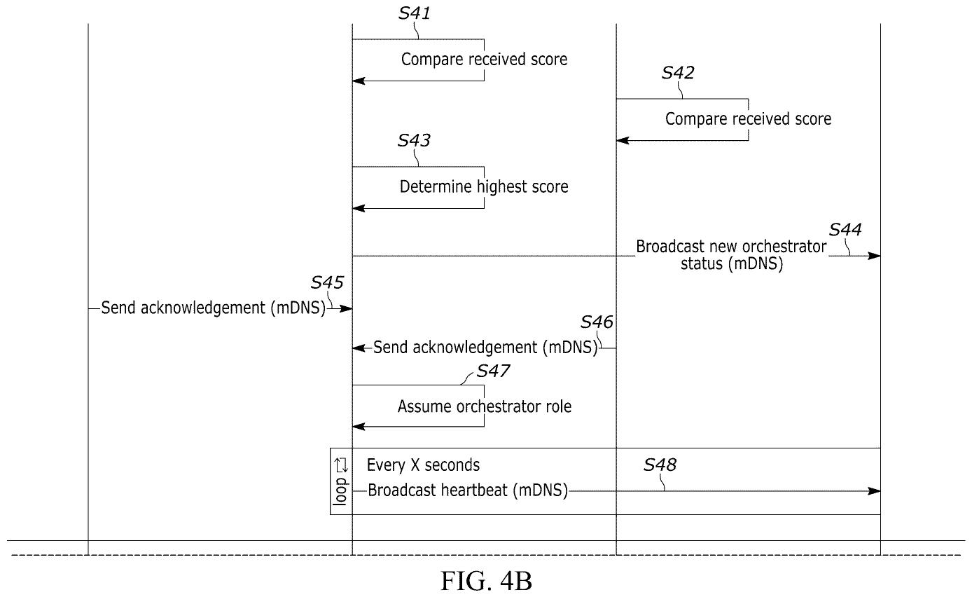

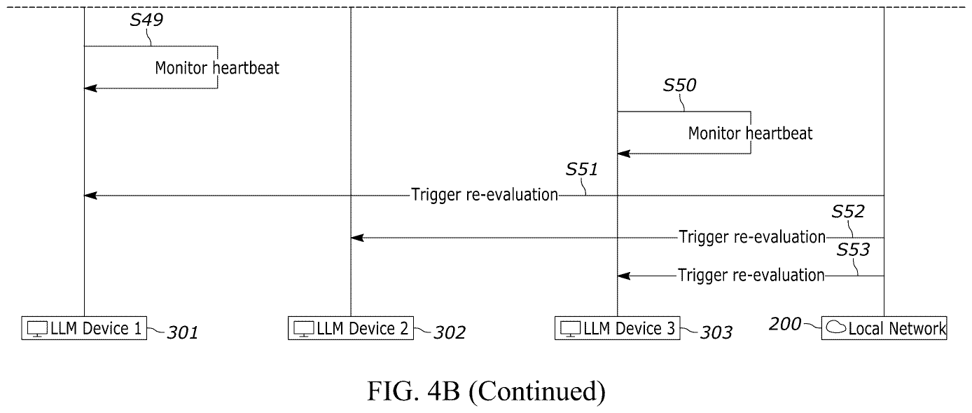

Now in reference to FIGS. 4A and 4B, an example step-by-step detailed process will be described for electing an orchestrator LLM device over mDNS protocol in a local network.

At steps S22-S24, all AI/LLM-enabled devices on the network may initialize their respective election module. Then at steps S25-S27, each AI/LLM device may use mDNS to broadcast its capabilities, including but not limited to processing power, available memory, specializations, current load, network position (e.g., latency to other devices).

Subsequently, at steps S28-S30, election may be triggered at each device. As examples, the election process may be triggered when no orchestrator is present, periodically to ensure the best orchestrator is always selected, and/or when the current orchestrator's performance degrades.

Candidate identification may then occur at steps S31-S33. Here, the devices on the network may compare their capabilities against a predefined threshold to determine if they are eligible to be orchestrator candidates. Each device may similarly determine if other devices on the network 200 are themselves orchestrator candidates. In one particular example, the threshold itself may be the respective device's AI model being capable of coordinating tasks with other devices.

Then for the identified candidate devices, at steps S34-S36 each candidate device may calculate its priority score based on its capabilities and current status. Then at steps S37-S39, each candidate device 301-303 may use mDNS to broadcast or otherwise announce their respective priority scores to the network 200 (and hence other devices).

Thereafter, the election process may enter a comparison phase at steps S40-S42. Here, all devices on the network 200 may compare the received priority scores of other candidate devices. A winner determination may then be made at step S43, where the device with the highest priority score is determined to be the new orchestrator. Step S43 may be executed by the existing (operative) orchestrator, or based on consensus as described above.

Then at step S44, an orchestrator announcement may be made. Specifically, the winning (newly-elected) device may broadcast its new status as orchestrator device using mDNS. The other devices may subsequently send acknowledge of the new orchestrator by sending mDNS response messages at steps S45 and S46. The newly-elected orchestrator may then assume its role and begin coordinating tasks among the LLMs/AI models of the various devices at step S47.

Also note that a heartbeat mechanism may also be used consistent with present principles. As such, at step S48, the current orchestrator may periodically broadcast heartbeat messages using mDNS to signal its active status to the other devices on the network 200, with the other devices then monitoring the orchestrator's heartbeat at steps S49 and S50.

Then for failure detection, if the non-elected devices do not receive heartbeat messages from the orchestrator for a set/threshold period of time (e.g., one minute), they may trigger a new election at steps S51-S53. The system may then periodically re-evaluate the orchestrators performance and trigger a new election again if necessary, establishing dynamic re-evaluation for optimized performance.

It may now be appreciated that this process leverages mDNS for efficient communication in the local network while implementing a dynamic, capability-based leader election mechanism suitable for orchestrating LLMs and other AI models in a home environment.

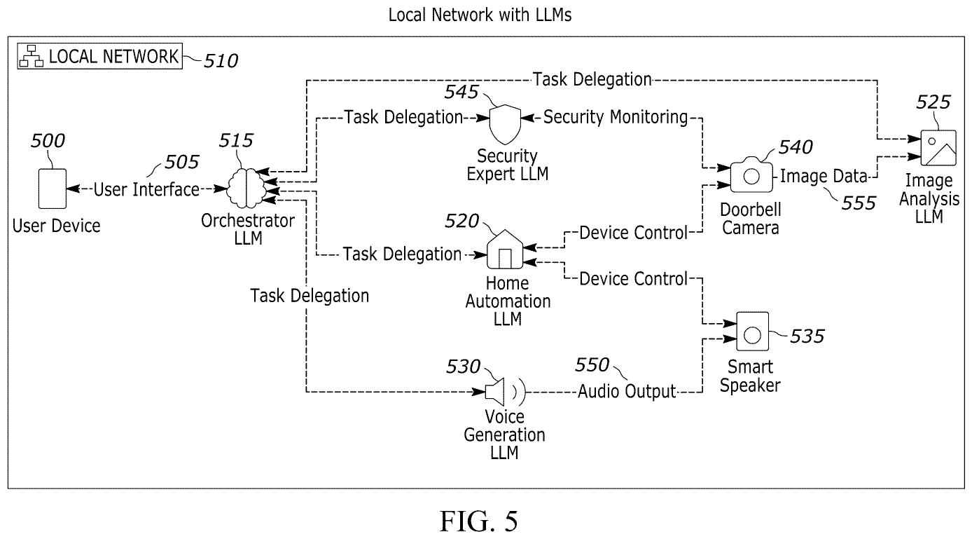

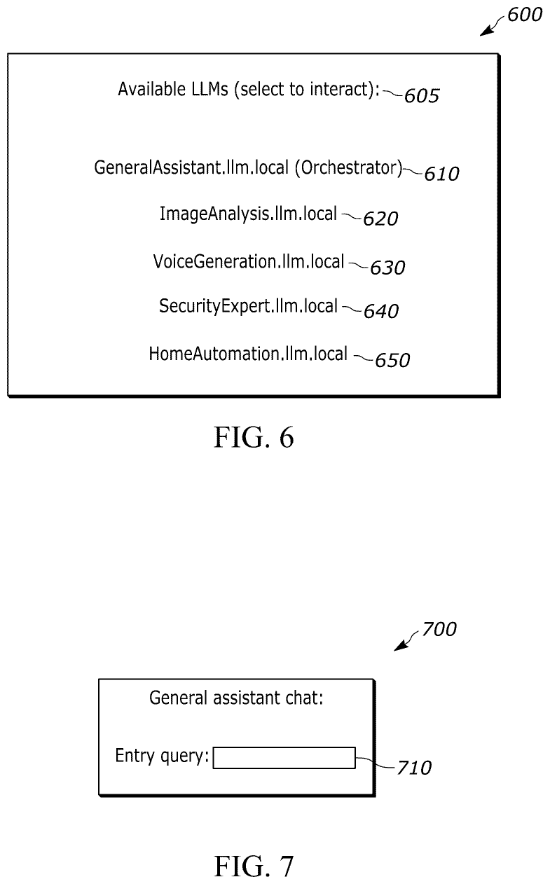

Continuing the detailed description in reference to FIG. 5, this figure shows an example schematic diagram of an example use case consistent with present principles. Suppose a user opens their home control application (“app”) at a client device 500 to access a user interface (UI) 505 through which the user can control different devices on the user's home network 510. The app may then use mDNS to discover available LLMs and other AI models on the local network 510 to then display a list of available LLMs. An example of this is shown in FIG. 6, where a graphical UI (GUI) 600 includes a prompt 605 to select one of the selectable options 610-650 to select the associated AI model itself (as available over the home network). Note that the currently-operative orchestrator is indicated for option 610 via the “orchestrator” text.

The end user can therefore see each AI model/LLM's capabilities and choose to interact directly with any of them by selecting a respective option 610-650 to then have a chat interface presented in response. The chat interface may be an audio interface where the user audibly interacts back and forth with the device, and/or may be a visual interface as shown via the GUI 700 of FIG. 7. Per FIG. 7, the user may select text entry box 710 to then enter a text-based natural language query for processing. Also note that the URL/IP address and port for each LLM's chat interface may be provided in the mDNS TXT records.

FIG. 5 also shows an orchestrator LLM 515 in action. Suppose the user types the following complex query into the GeneralAssistant chat using the GUI 700: “Someone's at the door. Can you check who it is and handle it appropriately?” In response, the orchestrator LLM (GeneralAssistant) 515 may break down or otherwise deconstruct this request into subtasks like:
a) Retrieve doorbell camera image.
b) Analyze the image to identify the person.
c) Determine appropriate action.

### D) Execute the Action.

FIG. 5 therefore also shows distributed task handling, where the orchestrator 515 may request the latest image 555 from the user's doorbell camera 540 via the HomeAutomation LLM 520. The image may then be sent to the ImageAnalysis LLM 525, which might identify the person as a door-to-door salesperson. The orchestrator 515, considering the identification, time of day, and user preferences (e.g., stored in its knowledge base), may decide to ask the salesperson to leave.

As such, the orchestrator 515 may send a text prompt to the VoiceGeneration LLM 530 indicating the following: “Politely inform the salesperson that we're not interested and ask them to leave.” The VoiceGeneration LLM may then create an audio message 550 using text-to-speech signals that it generates, which is then played out as audio through the doorbell speaker 535 via the HomeAutomation LLM 520.

The device may then provide feedback to the end user that provided the query. For example, the orchestrator LLM 515 may summarize the actions taken and report back to the user through the audible or visual chat interface: “A door-to-door salesperson was at the door. I've politely asked them to leave using the doorbell speaker. The SecurityExpert LLM will monitor the situation to ensure they depart.” The orchestrator LLM 515 may then delegate the ensuing monitoring task itself to the SecurityExpert LLM 545, which may monitor the front door area around the camera 540 using live video from the camera 540, analyzing the camera feed and updating the orchestrator 515 if any further action is needed.

Rounding out the description of FIG. 5, note for completeness that in some non-limiting examples, the orchestrator LLM 515 may also route communications to a remotely-located cloud-based LLM if the local LLMs are deemed inadequate for certain tasks in a given instance.

The schematic of FIG. 5, including its orchestrator task delegations, thus demonstrates various technical advantages of present principles. For example, it demonstrates dynamic discovery of available LLMs on the local network 510, user ability to interact directly with specific LLMs through a chat interface, an orchestrator LLM breaking down complex tasks and routing them to specialized LLMs, the handling of sensor data (doorbell camera) by domain-specific LLMs for optimal processing, a coordinated response involving multiple LLMs (e.g., ImageAnalysis, VoiceGeneration, HomeAutomation, SecurityExpert), and seamless integration of various smart home functions through distributed LLM cooperation.

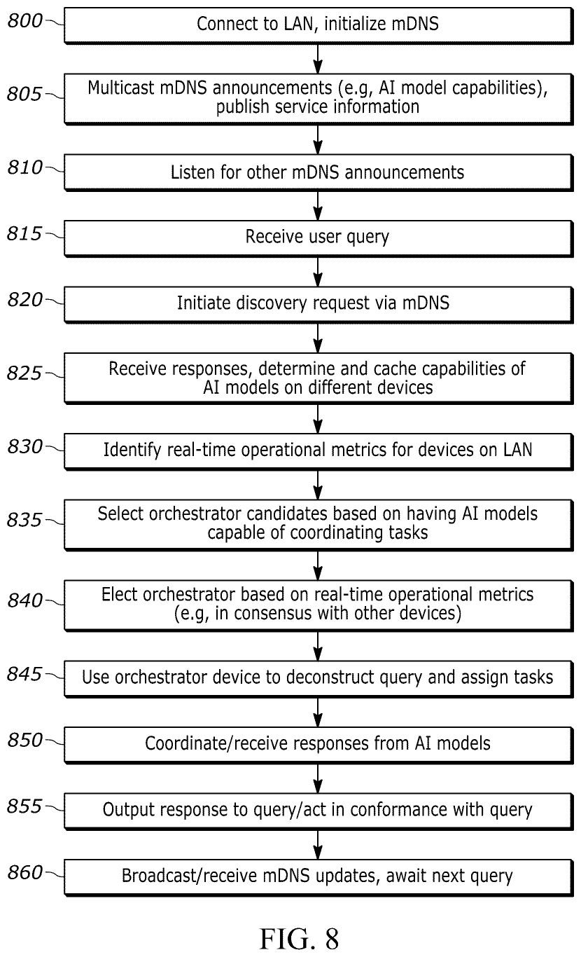

Referring now to FIG. 8, this figure shows example logic that may be executed by an apparatus such as the system 100, one or more of the devices 301-303, and/or another AI-enabled device on a secure LAN consistent with present principles. Note that while the logic of FIG. 8 is shown in flow chart format, other suitable logic may also be used.

Beginning at block 800, a first device may use its network system to connect to a LAN and initialize an mDNS process as described above. The logic may then proceed to block 805 where, responsive to detecting that the network system has connected to the LAN, the first device may share (e.g., broadcast or multicast) mDNS announcements as described above, including multicasting one or more capabilities of the AI model(s) stored at and executable locally on the first device itself. Also at block 805, the first device may publish its service information as described above.

From block 805 the logic may then proceed to block 810. At block 810 the device may listen for other mDNS announcements as described above. From block 810 the logic may then proceed to block 815.

At block 815 the first device may receive or otherwise identify user input indicating a query. The logic may then proceed to block 820 where the first device may initiate a discovery request via mDNS in response. Then at block 825 the first device may receive back responses to the discovery request from other devices, and also determine and cache the respective capabilities of the AI models on those other devices as indicated in the responses themselves.

From block 825 the logic may then proceed to block 830 where the first device may identify one or more real-time operational metrics for each device from which a response was received if that device is determined to be a candidate for orchestrator as discussed above. For example, candidate devices may be selected for election at block 835 based on the respective devices each having a respective AI model capable of coordinating tasks with other devices on the network. The logic may then proceed to block 840 where an orchestrator device is elected for coordinating tasks based on analysis of the respective real-time operational metrics for each candidate device as discussed above. For example, the first device itself may be elected over other candidate devices based on a system consensus that real-time operational metrics for the first device indicate more resource availability than the real-time operational metrics for the other candidate devices. Again note that resource availability may pertain to available processor (e.g., central processing unit (CPU), graphics processing unit (GPU), and/or or neural processing unit (NPU)) utilization amount, available memory utilization amount, available transceiver utilization amount, available persistent storage utilization amount, available GPU utilization amount, etc.

Still in reference to FIG. 8, the logic may continue on to block 845. At this step the first (now orchestrator) device may be used to deconstruct the user's query into different respective tasks for execution by different AI models that are currently active on the LAN. The first device may then delegate or otherwise assign the respective tasks to respective AI models to address the query, with each task being delegated based on a determined capability of the respective AI model on the relevant device itself being suitable to perform the associated task.

From block 845 the logic may proceed to block 850 where the first device may receive response data from each device to which a task was assigned. The data may indicate a respective output from the respective AI model on that device as executed in conformance with the assigned task.

Also at block 850, the first device may coordinate outputs amongst the devices to respond to or otherwise address the user's query. For example, the first device might prompt an LLM to generate text, receive the output from the LLM indicating the generative text itself, and then provide the generated text to a text-to-speech (TTS) model with a prompt for the TTS model to generate audio signals indicating words corresponding to the generated text. Also note that the description of FIG. 5 above describes other coordination examples consistent with present principles.

The logic of FIG. 5 may then proceed to block 855 where the first device may output a response to the query or otherwise act in conformance with the query itself (e.g., continue to monitor the front door area per the example of FIG. 5). The logic may then proceed to block 860 where the first device may continue to multicast and receive mDNS updates while awaiting a next user query to act upon. Note that the orchestrator device might be switched during this time consistent with the disclosure above.

It may now be appreciated that present principles provide for an improved computer-based user interface that increases the functionality and ease of use of the devices disclosed herein. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A first device, comprising:
a processor system;
a network system configured to connect to a local area network (LAN); and
storage accessible to the processor system and comprising instructions executable by the processor system to:
identify user input indicating a query;
determine one or more first capabilities of a first artificial intelligence (AI) model executable on a second device connected to the LAN;
determine one or more second capabilities of a second AI model executable on a third device connected to the LAN;
deconstruct the query into at least a first task and a second task, the first task being different from the second task; and
based on the determinations, assign the first task to the first AI model and assign the second task to the second AI model.

2. The first device of claim 1, wherein one or both of the first and second AI models comprise a large language model (LLM).

3. The first device of claim 1, wherein the instructions are executable to:
receive, from the second device, first data indicating a first output from the first AI model as executed in conformance with the first task;
receive, from the third device, second data indicating a second output from the second AI model as executed in conformance with the second task; and
output a response to the query based on the first and second data.

4. The first device of claim 1, wherein the instructions are executable to:
deconstruct the query into the first and second tasks based on the identified one or more first capabilities of the first AI model and the one or more second capabilities of the second AI model.

5. The first device of claim 1, wherein the instructions are executable to:
elect the first device as an orchestrating device for coordinating the first and second tasks.

6. The first device of claim 5, wherein the instructions are executable to:
identify one or more first real-time operational metrics for the first device;
identify one or more second real-time operational metrics for a fourth device; and
elect the first device based on analysis of the first and second real-time operational metrics.

7. The first device of claim 6, wherein the first device and the fourth device are selected as candidates for election based on the first device and fourth device each having a respective AI model capable of coordinating tasks with other devices.

8. The first device of claim 6, wherein the instructions are executable to:
elect the first device over the fourth device based on the first real-time operational metrics indicating more resource availability than the second real-time operational metrics.

9. The first device of claim 8, wherein the instructions are executable to:
elect the first device in consensus with one or more of: the second device, the third device, the fourth device.

10. The first device of claim 8, wherein the fourth device is one of: the second device, the third device.

11. The first device of claim 8, wherein resource availability pertains to one or more of: processor utilization amount, memory utilization amount.

12. The first device of claim 1, wherein the instructions are executable to:
share one or more third capabilities of a third AI model responsive to detecting that the network system has connected to the LAN, the third AI model being executable on the first device.

13. The first device of claim 12, wherein the one or more third capabilities are shared using a multicast Domain Name System (mDNS) protocol.

14. A method, comprising:
identifying user input indicating a query;
determining one or more first capabilities of a first artificial intelligence (AI) model executable on a first device connected to a local area network (LAN);
determining one or more second capabilities of a second AI model executable on a second device connected to the LAN;
based on the determinations, assigning a first task to the first AI model to address the query and assigning a second task to the second AI model to address the query; and
coordinating the first and second tasks to address to the query.

15. The method of claim 14, wherein the first AI model is a large language model (LLM), and wherein the second AI model is a text-to-speech model.

16. The method of claim 15, wherein coordinating the first and second tasks to address to the query comprises:
prompting the first AI model to generate text; and
providing the generated text to the second AI model for the second AI model to generate audio signals indicating words corresponding to the generated text.

17. The method of claim 14, comprising:
deconstructing the query into the first task and the second task; and
based on the determinations and the deconstruction, assigning the first task to the first AI model to address the query and assigning the second task to the second AI model to address the query.

18. The method of claim 14, wherein the one or more first capabilities and the one or more second capabilities are determined via a multicast Domain Name System (mDNS) protocol.

19. An apparatus, comprising:
at least one computer readable storage medium (CRSM) that is not a transitory signal, the at least one CRSM comprising instructions executable by a processor system to:
determine one or more first capabilities of a first model executable on a first device connected to a network;
determine one or more second capabilities of a second model executable on a second device connected to the network;
based on the determinations, assign a first task to the first model to address a query and assign a second task to the second model to address the query; and
coordinate the first and second tasks to respond to the query.

20. The apparatus of claim 19, wherein coordinating the first task comprises prompting the first model to execute the first task, and wherein coordinating the second task comprises prompting the second model to execute the second task.
